(19) United States
(12) Patent Application Publication
(10) Pub. No.: US 2009/0101278 A1
(43) Pub. Date: Apr. 23, 2009

(54) METHODS FOR PREPARING FREEFORM THREE-DIMENSIONAL STRUCTURES

(76) Inventors: Louis Laberge-Lebel, Montreal (CA); Daniel Therriault, Saint-Laurent (CA); My Ali El Khakani, Saint-Lambert (CA); Brahim Aissa, Saint-Leonard (CA)

Correspondence Address: BERESKIN AND PARR, 40 KING STREET WEST, BOX 401, TORONTO, ON, M5H 3Y2, CA

(21) Appl. No.: 12/252,722

(22) Filed: Oct. 16, 2008

Related U.S. Application Data
(60) Provisional application No. 60/980,720, filed on Oct. 17, 2007.

(51) Int. Cl. B05D 3/06; B29C 65/48

(52) U.S. Cl. 156/275.5; 427/487; 427/508

(57) ABSTRACT

There are provided methods for the real-time radiation-assisted fabrication of freeform three-dimensional structures. For example, one of these methods comprise depositing on a substrate, by means of nozzle, a filament comprising a curable polymer, while exposing the filament to a radiation so as to cure the curable polymer, and while moving the substrate and the nozzle, with respect to one another, according to the x-axis, y-axis, and z-axis or at least two of these axes. Such a method permits to obtain a freeform three-dimensional structure having at least one point of contact with the substrate.

### CROSS-REFERENCE TO RELATED APPLICATION

The present application claims priority on U.S. provisional application No. 60/980,720 filed on Oct. 17, 2007.

### FIELD OF THE DISCLOSURE

The present disclosure relates to the field of production of various structures such as those comprising a curable polymer. In particular, the present disclosure relates to freeform fabrication of three-dimensional structures such as microscopic and macroscopic structures.

### BACKGROUND OF THE DISCLOSURE

Usual methods for fabricating micro or macroscopic pieces commonly use moulds. They use an initial material, which is set into a mould from which the final product is formed with or without post-curing or hardening. In some cases the mould is destroyed revealing thus the targeted pieces. Other methods for fabricating composite material products (for example automated tape placement or filament winding) use the robotic deposition of preimpregnated fibers on a substrate. The substrate (for example: mold or mandrel), its nature and shape are central to these techniques, as the structures to be formed have to be deposited in sequential steps (or in a layer-by-layer scheme) on the substrate, which has to be rigid enough to allow the hardening of the deposited material.

Other approaches in microelectronic use ultra violet lithography followed by many steps such as deposition, etching, stripping, and cleaning before reaching the fabrication of a given microstructure. These types of processes have to be iterated many times (in a layer-by-layer scheme) to allow to build up the targeted 3D structures. Such a microfabrication approach implies a rather heavy infrastructure and relatively high operation costs. They do not however permit the direct formation of freeforms, Thus, they are refereed to as two-dimensional structures piled-up in a in a third dimension.

Direct Writing Processes (DWP) are commonly used to build complex 3D pieces. Known methods include, for instance, fused deposition, two-photon polymerization and selective laser sintering. These techniques use layer by layer deposition to obtain a 3D product. In two-photon polymerization, the localized polymer's hardening is done, for example, via the use of an infrared or ultraviolet laser. To realize a 3D structure, one has to move it down, to cover it with a new layer of polymer and to expose it under the laser. In fused deposition, the material is added to the previously deposited ones with a nozzle. The nozzle heats the material before projecting it to the construction. Once cooled down, it forms a new layer. Finally, the selective laser sintering method is a process where a ceramic material is hardened from a cutting powder. A laser activates the sintering localized at the surface of a sintering bath. Once a layer finished, a fine powder layer is added to the structure and a new stage of the product can be sintered until the completion of the desired shape.

All these methods have some common limitations. First, the range of materials available for each of them is very small. For instance, two-photon polymerization works only with photopolymers, fused deposition with fusible materials, and “selective laser sintering” with ceramic materials. Secondly, using these techniques the structure needs to be physically supported. When an object is built layer-by-layer, it happens that part of the object is in an upper layer but absent in the lower ones. Consequently, a support has to be built in the lowest layers to support the part of the product, which will be built higher. Thirdly, these approaches can not be used straightforwardly to build curves in the vertical plane. Finally, all these techniques require controlled environments.

The manufacturing technique by direct laser writing builds microscopic self-condensing pieces from a gas that is exposed under a laser in a controlled environment.

It would thus be highly desirable to be provided with a method that would overcome at least one of the above-mentioned drawbacks.

### SUMMARY OF THE DISCLOSURE

According to one aspect, there is provided a method of producing a structure, the method comprising:

depositing on a substrate, by means of a nozzle, a filament comprising a curable polymer, while exposing the filament to a radiation so as to cure the curable polymer, and while moving the substrate and the nozzle, with respect to one another, according to at least two axes chosen from the x-axis, y-axis, and z-axis, in order to obtain a freeform three-dimensional structure having at least one point of contact with the substrate.

According to another aspect, there is provided a method of producing a structure, the method comprising:

depositing on a substrate, by means of a nozzle, a filament comprising a curable polymer, while exposing the filament to a radiation so as to cure the curable polymer, and while moving the substrate and the nozzle, with respect to one another, according to the x-axis, y-axis, and z-axis, in order to obtain a freeform three-dimensional structure having at least one point of contact with the substrate.

According to another aspect, there is provided a method of producing a structure, the method comprising:

depositing on a substrate, by means of a nozzle, a composition comprising a curable polymer, optionally an initiator, optionally an enhancing property agent, and optionally a pseudoplasticizer, while exposing the composition to a radiation so as to cure the curable polymer, and while moving the substrate and the nozzle, with respect to one another, according to at least two axes chosen the x-axis, y-axis, and z-axis, in order to obtain a freeform three-dimensional structure having at least one point of contact with the substrate.

According to another aspect, there is provided a method of producing a structure, the method comprising:

depositing on a substrate, by means of a nozzle, a composition comprising a curable polymer, optionally an initiator, optionally an enhancing property agent, and optionally a pseudoplasticizer, while exposing the composition to a radiation so as to cure the curable polymer, and while moving the substrate and the nozzle, with respect to one another, according to the x-axis, y-axis, and z-axis, in order to obtain a freeform three-dimensional structure having at least one point of contact with the substrate.

According to one aspect, there is provided a method of producing a structure, the method comprising:

bridging together a first substrate and a second substrate by depositing on the substrates, by means of a nozzle, a filament comprising a curable polymer, while exposing the filament to a radiation so as to cure the curable polymer, and while moving the nozzle, according to at least one of x-axis, y-axis, and z-axis, in order to obtain a freeform three-dimensional structure between the first and second substrates, the structure having at least one point of contact with the first substrate and at least one point of contact with the second substrate.

It has been found that such methods can be used for preparing various types, shapes and sizes of structures. For example, these methods can be used for preparing self-supported structures and structures that stand on their own and that have for example, only one or two point of contact with the substrate. Such structures can have various shapes such as curved shapes, straight shapes, spiral shapes, elbowed shapes, angled shapes, or shapes comprising various angles, etc. In other words, three-dimensional complex shapes can be fabricated real-time and in a straightforward way with these low-cost methods. The methods offer the flexibility to use different curable polymers, which can be provided with various enhancing property agents such as various nanomaterials or nanocomposites. For example, these methods are efficient to prepare structures having sizes ranging from micrometer(s) to centimeter(s). By using these methods, such structures can be efficiently prepared at low costs since they can be rapidly fabricated without any need of any post-processing. For example, these methods can be carried out by rapidly curing (for example almost instantaneously) the curable polymer so as to manufacture in real time without the need of any further processing the desired structures. In fact, when using such methods, there is no need for using a mold, a die, a lithographic mask or a bath comprising various reagents or polymers. These methods can be carried out in a single step. Such methods can be carried out in a considerably limited space since they do not require the use of cumbersome setups. Moreover, these methods can be used to prepare the previously mentioned structures in a single step. These methods can also be carried out at room temperature under an ambient air atmosphere, which considerably simplifies the production process of such structures and lowers the production costs. For example, these methods enable to monitor the position and the concentration of the load in space. Indeed, these methods can allow the precise positioning of the composition or filament at desired locations in the 3D space. For example, if the load has an asymmetrical shape, these methods can enable to control the orientation of the load in space. These methods can be efficient for preparing various composites, thermally and electrically conductive polymers, etc.

In the methods previously mentioned, the composition or filament can be fed through the nozzle at a feeding rate, which is similar to a displacement rate of the relative movement of the nozzle and the substrate with respect to one another. For example, the feeding rate and the displacement rate can be adjusted as a function of a curing rate of the polymer. The curing rate can be similar to the feeding rate and similar to the displacement rate. The curing rate can also be higher than the feeding rate and higher than the displacement rate. For example, the feeding rate can be about the same than the displacement rate. For example, when bridging two substrates with a filament as previously described, the feeding rate and the displacement rate can be similar to the curing rate. For example, such a method for bridging is quite efficient for producing self-supported beams between two different substrates. The beams can be linear, curved, zig-zaged or have any other free irregular form. For example, the diameter of the beams can vary from micrometers to several millimetres. For example, the length of the beams can vary from a few microns to a few centimetres. It is also possible to use the other methods previously disclosed in order to prepare such a beam that has at least two points of contact with a same substrate. For example, the structure and substrate are not in contact with one another between these points of contact.

For example, the filament can be deposited on the substrate, by means of the nozzle, while exposing the filament that exits from the nozzle to the radiation, and while moving the substrate and the nozzle, with respect to one another, according to the x-axis, y-axis, and z-axis or at least two of these axes, so as to obtain the freeform three-dimensional structure. The depositing and moving can be carried out in such a manner that the structure has a single point of contact with the substrate. For example, the point of contact can be made at the beginning of the method. Such a point of contact can be located at an extremity portion of the structure.

In the methods previously mentioned, the filament can further comprise at least one component. Such component can be chosen from initiators, pseudoplasticizers, enhancing property agents, and mixtures thereof. For example, the initiator can be chosen from suitable polymerization initiators such as radical initiators (for example various organic peroxides, 1,1′-azobis(cyclohexanecarbonitrile), 2,2′-azobis(2-methylbutyronitrile), 2,2′-azobis(2-methylpropionitrile), 2,2′-azobis(2-methylpropionitrile), etc.), thermal initiators (for example tert-amyl peroxybenzoate, t-butyl peracetate, and various metal catalysts), photoinitiators (for example UV-photoinitiators such as α-aminoalkyl-phenones, thio-xanthones-amines, and visible photoinitiators such as metallocenes (titanocenes). The photoinitiators can also include acetophenones, benzil and benzoin compounds, benzophenones, cationic photoinitiators, and thioxanthones. The thermal initiators can also include azo compounds, inorganic peroxides, and organic peroxides. For example, the pseudoplasticizer can be chosen from fumed silicas, fused silicas, liquid crystal particles, prussian blue pigments, calcium hydroxide particles, microcrystalline waxes or any other fluidizing or viscosity controlling agent. For example, the property enhancing agent can be chosen from nanometric filamentary structures, nanopowders, and mixtures thereof. For example, the nanometric filamentary structures can comprise nanowires, nanorods, nanofibers, nanoribbons, nanotubes or bundles thereof, or mixtures thereof. The nanometric filamentary structures can be, for example, carbon nanometric filamentary structures. Non-limitative examples of carbon nanometric filamentary structures include single-wall carbon nanotubes, multi-wall carbon nanotubes, carbon nanometric fibers, etc. For example, the nanometric filamentary structures can be one-dimensional nanostructures (such as nanowires, nanorods, nanofibers, nanoribbons, or nanotubes or bundles thereof) of a member chosen from C, BN, B, Si, Ge, Bi, Sn, Te, Se, Hg, Si₃N₄, V₂O₃, MX₂ wherein M is Ti, Zr, Hf, Nb, Ta, Mo, W or Re and X is S, Se or Te, InP, InAs, GaN, GaP, GaAs, Ga₂O₃, ZnO, In₂O₃, Na₂V₃O₇, Al₂O₃, B₂O₃, MgO, CdO, SiO₂, SnO₂, CuO, (SN)ₓ, Cu₂S, BₓC_{y}N_{z}, NiCl₂, InS, ZnS, ZnSe, CdS, CdSe, Ag₂Se, SiC, B₄C, M₂MoX₆ wherein M is Li or Na and X is Se or Te, coated structures thereof and mixtures thereof. Nanopowders of the compounds previously mentioned can also be used as well as nanoclays, or nano-carbon black. When using in the composition or filament one or more components as previously described, it is possible to obtain, in a single step, complex structures of microcomposites and/or nanocomposites.

In the methods previously mentioned, the curable polymer can be chosen from epoxy resins, polyesters, polyurethanes, poly(methyl methacrylates), acrylics, alkyds, amino resins, bismaleimides, furanes, phenolics, polyimides, vinyl esters, cyanate esters, silicones, arylzene resins, rubbers, synthetic rubbers, UV curable hydrogels, and mixtures thereof. In these methods, the curable polymer can be used alone or it can be mixed with various components as previously disclosed. For example, the composition or filament can consist in the curable polymer or it can comprise the curable polymer and at least one other component. Such an at least one component can be chosen from the various components described in the present document. The radiation can be visible, infrared, ultraviolet, X-rays or any appropriate combination of thereof or can be a beam of electrons or ions that can change the properties of the processed polymer and/or nanocomposite and therefore those of the filament. For example, UV radiation can be used (such as UV radiation having a wavelength of 365 nm). The person skilled in the art will understand that the type of radiation used can be determined as a function of the nature of the curable polymer used. The curing rate will also be a function of these two variables. The person skilled in the art can thus select the curable polymer and source of radiation in accordance with a desirable curing rate to obtain. The person skilled in the art will also understand that the feeding rate will be influenced by the viscosity of the composition or filament, which varies in accordance with the pressure exerted in the nozzle, as well as the nature of the optional components present in the composition or filament.

In the methods previously mentioned, the feeding rate and the displacement rate will be adjusted as a function of the curing rate. For example, when using a polyurethane, the feeding rate can be about 0.4 mm/s to about 10 mm/s, about 0.5 mm/s to about 7 mm/s, or about 0.5 mm/s to about 1.0 mm/s.

In the methods previously mentioned the composition can be deposited in various forms such as a filament. The composition can be deposited in a continuous manner. It is also possible to eventually change the cross section geometry of the nozzle. For example, the filament can have various shapes (i.e. round, square, triangular, etc.

In the methods previously mentioned, the nozzle can be, for example, a syringe operated by a robotic displacement system. The composition or filament is then fed or extruded via the nozzle of the syringe. The nozzle can also be protected with a mask so as to prevent radiation from contacting an extremity of the nozzle (for example the syringe or the tip of the syringe). For example, the robotic displacement system and the substrate can; be adapted to operate freely in up to 6 degrees of freedom (i.e.; x, y and z translational degrees in conjunction with the θ, φ, ψ rotational degrees), with respect to one another.

For example, the filament can be deposited on the substrate, by means of the nozzle, while exposing the filament that exits from the nozzle to a radiation, and while moving the substrate and nozzle, with respect to one another, according to the x-axis, y-axis, and z-axis, so as to obtain the freeform three-dimensional structure. The depositing and moving can be carried out in such a manner that the structure has at least two points of contact with the substrate. For example, these two points of contact can be at opposite end portions of the structure. For example, the structure can have 2, 3, 4 or more points of contact with the substrate.

In the methods previously mentioned, a first portion of the composition can be deposited on the substrate and exposed to the radiation so as to cure the curable polymer and then, at least one other subsequent portion of the composition can be deposited on the first portion while exposing the at least one subsequent portion of composition to the radiation so as to cure the curable polymer, and while moving the substrate and the nozzle, with respect to one another, according to the x-axis, y-axis, and z-axis. For example, the portions can be successively deposited in a continuous manner. For example, all portions subsequent to the first portion are deposited on a previous deposited and cured portion or at least partially cured portion. For example, the composition can be fed through the nozzle at a feeding rate which is about the same than a displacement rate of the relative movement of the nozzle and the substrate with respect to one another. The feeding rate and the displacement rate can be adjusted as a function of a curing rate of the polymer. The curing rate can be higher than the displacement rate and the feeding rate. The curing rate can also be similar to the feeding rate and similar to the displacement rate.

The methods previously mentioned can further comprise removing said structure(s) from said substrate so as to separate them from one another. Alternatively, the structure(s) can be cut so as to remove it from the substrate, thereby optionally leaving a residual portion of the structure(s) on the substrate.

In the method for bridging two substrates previously mentioned, the method can comprise sequentially contacting the first substrate and then the second substrate, the deposition being carried out while exposing the filament to a radiation so as to cure the curable polymer, and while moving the nozzle towards the second substrate, according to at least one of x-axis, y-axis, and z-axis, in order to obtain the freeform three-dimensional structure between the first and second substrates. For example, such a structure can have a single point of contact with the first substrate and a single point of contact With the second substrate. Such a method can be carried out at least two times in order to bridge the substrates with at least two structures, which can be same or different. Various substrates can be bridged by using such a method. For example, such a method can be used for bridging two substrates of any form (i.e; planar, cylindrical, tubular, spherical, or any combination of these) or nature (metallic, ceramic, plastic, etc. . . . ). For example, at least one of the substrates can be chosen from a rod, a cylinder, a cube, a complex scaffold, a spiral, and a sphere.

The expression “while moving the substrate and the nozzle, with respect to one another, according to the x-axis, y-axis, and z-axis” as used herein refers, for example, to a relative displacement of the substrate and the nozzle with respect to one another that has at least one component on each axis (x, y and z). Such a movement or a moving action can comprise at least one translation movement, at least one rotation movement, or any combinations thereof. For example, such an expression is not limited to a particular order of displacement on these axes but rather encompasses any possible combinations as long as the movement has at least one component on each of the x, y, and z axes. For example, such an expression can refer to a case in which the substrate is immovable and in which the nozzle is movable according to the x-axis, y-axis, and z-axis or to a case in which the nozzle is immovable and in which the substrate is movable according to the x-axis, y-axis, and z-axis. For example, this expression can also refer to a case in which the substrate is movable according to the x-axis and y-axis and in which the nozzle is movable according to the z-axis.

The expression “while moving the substrate and the nozzle, with respect to one another, according to at least two axes chosen from the x-axis, y-axis, and z-axis” as used herein refers, for example, to a relative displacement of the substrate and the nozzle with respect to one another that has at least one component on at least two axes chosen from the x-axis, y-axis, and z-axis. Such a movement or a moving action can comprise at least one translation movement, at least one rotation movement, or any combinations thereof. For example, such an expression is not limited to a particular order of displacement on these axes but rather encompasses any possible combinations as long as the movement has at least one component on at least two of these axes. For example, such an expression can refer to a case in which the substrate is immovable and in which the nozzle is movable according to the x-axis and z-axis or to a case in which the nozzle is immovable and in which the substrate is movable according to the y-axis and z-axis. For example, this expression can also refer to a case in which the substrate is movable according to the x-axis and in which the nozzle is movable according to the z-axis. Such an expression also encompasses the examples previously mentioned concerning the expression “while moving the substrate and the nozzle, with respect to one another, according to the x-axis, y-axis, and z-axis”.

The term “similar” as used herein refers, for example, when used for comparing two numerical values, such as rates, refers to two numerical values that have a difference of less than 20%. When such a term is used for comparing more than two numerical values, such as rates, it means that the difference between the highest and the lowest value is less than 20%.

The expression “is about the same” as used herein refers, for example, when used for comparing two numerical values, such as rates, refers to two numerical values that have a difference of less than 10%. When such an expression is used for comparing more than two numerical values, such as rates, it means that the difference between the highest and the lowest value is less than 10%.

The expression “displacement rate” as used herein refers, for example, to the rate of the relative movement between the nozzle and the substrate. Such a displacement rate is the resultant of the displacement according to at least one axis.

### BRIEF DESCRIPTION OF THE DRAWINGS

In the appended drawings which represent various examples:

FIG. 1 is an image of a structure prepared in accordance with one of the methods previously mentioned, wherein the structure has a spiral shape;

FIG. 2 is an image of another structure prepared in accordance with one of the methods previously mentioned, wherein the structure has a spiral shape;

FIG. 3 is an image of structures prepared in accordance with one of the methods previously mentioned, wherein the structures are beams bridging two substrates, the upper part of FIG. 3 being a top view of the beams and substrates and the lower part of FIG. 3 being a side view of the beams and substrates; and

FIG. 4 is an image of structures prepared in accordance with one of the methods previously mentioned, wherein the structures are two sets of filaments and these sets are orthogonal and superposed with respect to one another.

### DETAILED DESCRIPTION OF THE DISCLOSURE

The following examples are presented in a non-limitative manner.

### Materials

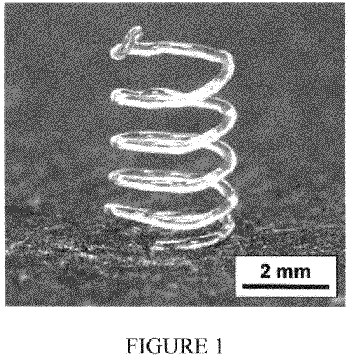

The structures presented in FIGS. 1 to 4 comprise two different materials: a commercially available polyurethane resin and a single-wall carbon nanotubes/polyurethane nanocomposite.

The commercially available resin (NEA123T, Norland Products) used for the spiral fabrication was a polyurethane with an ultraviolet (UV) photo-initiator and a heat catalyst or thermal initiator. The resin also contained a low amount (˜5 wt. %) of fumed silica nanoparticles (Aerosil 200, Degussa) to increase its viscosity (˜400 Pa·s) and pseudoplastic behavior.

The nanocomposite material was a mixture of single walled carbon nanotubes (C-SWNTs) with a commercially available polyurethane matrix (NEA123MB, Norland Products). A little amount of the surfactant Zinc Protoporphyrin IX (ZnPP, Sigma-Aldrich) was used to help disperse the C-SWNT and ˜5 wt. % of fumed silica nanoparticles (Aerosil 200, Degussa) to control the viscosity was also added. Weighted amount of C-SWNT was first dispersed in a solution of 0.1 mM of ZnPP in dichloromethane (DCM, Sigma-Aldrich) by immerging the flask in an ultrasonic bath (Ultrasonic cleaner 8891, Cole-Parmer) for 30 min. After ultrasonication, the C-SWNTs were poured in a beaker and placed over a stirring hot plate (Model SP131825, Barnstead international). A controlled amount of polyurethane was then slowly added to the C-SWNT solution while mixing at 800 RPM for 30 minutes. Complete removal of the DCM solvent was obtained by placing the solution in a vacuum jar at full vacuum for 2 days. The obtained nanocomposite mixture was passed several times in a three roll mixer mill (80E, Exakt) where the gap between the rolls and the speed of the apron roll are controlled. The total procedure consisted of 5 passes at a gap of 25 μm and speed 200 RPM, 5 passes at a gap of 15 μm and speed 200 RPM and finally 9 passes at a gap of 5 μm and speed 250 RPM. The nanocomposite was then slowly added to 200 ml of DCM already containing the necessary amount of fumed silica in a beaker over a stirring hot plate at 800 RPM. The solution was heated at 35° C. to partially evaporate the DCM. This step concentrated the nanocomposite but the solvent left lowers the viscosity allowing the mixture to be poured inside the 3 cc syringes. After room condition evaporation for 2 days, the syringes were placed overnight inside a vacuum oven for a final evaporation step realized at 35° C. and full vacuum to remove the DCM solvent.

The C-SWNTs inside the nanocomposite were produced by a pulsed laser vaporization technique, using an excimer KrF laser (λ=248 nm, t=15 ns, E=100 mJ/pul, f=30 Hz). The C-SWNT material was obtained by laser-ablating a Co/Ni doped graphite pellet (0.6%/0.6% atm.) at a temperature around 1100° C. under a controlled argon atmosphere (˜500 Torr). An acidic treatment was used to purify the obtained material (to dissolve metal catalysts and amorphous carbon). In this procedure, raw sample of C-SWNTs was placed in HNO₃ (Sigma Aldrich) solution (3M). After ultrasonication, the samples were refluxed for 5 h at 130° C. The suspension was then filtered using a 0.22 μm porous poly-tetrafluoroethylene membrane (Filter type-GV, Millipore corp.).

### Deposition System

The deposition system was composed of a computer controlled robot (I&J220-4, I&J Fisnar) that moved a substrate or platform along the x axis. The robot also moved a dispensing apparatus (HP-7X, EFD) along the y and z principal axes and around the z principal axis, over the platform. The programmed deposition path of the robot was specified in a control software (JR Points for Dispensing V 4.85E, Janome Sewing Machine Co., Ltd.) where the specified moving speed was the resultant vectorial sum of the speeds along the motion axes. Hence, the specified moving speed was the relative speed of the dispensing apparatus with respect to the platform surface. A removable substrate consisting of a glass slide or a black paper was placed onto the robot platform. The material or composition, stored inside a 3 cc syringe barrel, was fed or extruded through a micronozzle under constant pressure using the dispensing apparatus. UV radiation was directed on the extruded filament using two UV LEDs (wavelength of 365 nm; 350 mW/cm²; NCSU033A, Nichia). The extrusion point was shadowed with a masking device to prevent the hardening of the deposited material inside the tip of extrusion nozzle. The pseudo-plastic behavior makes the viscosity of the resin dependent of the shear rate that it is subjected. It allows the material to flow through the extrusion nozzle at high shear rates because of a viscosity decrease. After the material exits the extrusion nozzle, the shear rate at which it is exposed returns to zero. The viscosity increase allows the extruded filament to keep its shape while it is cured by the exposition to the UV radiation.

### EXAMPLES

### Example 1

FIG. 1 shows a cured resin spiral having 5 coils, an outside diameter of ˜3 mm and an overall height of ˜5.3 mm. For the spiral fabrication, the extrusion nozzle had an internal diameter of 200 μm (5127-0.25-B, Precision Stainless Steel Tips, EFD). Swelling occurred on the extruded filament hence the spiral filament has a diameter of approximately 280 μm. The pressure applied was 812 kPa and the displacement rate of the nozzle was 0.6 mm/s. The feeding rate, controlled by the pressure applied, was about the same than the displacement rate. The curing rate was superior than the feeding rate and superior than the displacement rate.

### Example 2

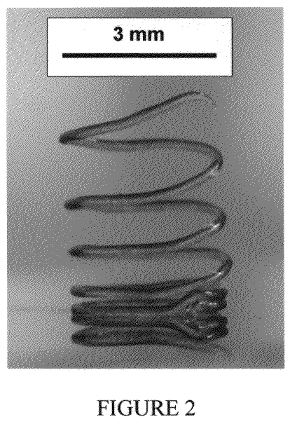

FIG. 2 shows a cured 0.25 wt. % C-SWNT/polyurethane nanocomposite spiral having 5 coils, an outside diameter of ˜3 mm and an overall height of ˜4.6 mm. The spiral filament has a diameter of ˜250 μm, which is larger than the nozzle internal diameter of 200 μm (5127-0.25-B, Precision Stainless Steel Tips, EFD) due to swelling of the extrusion filament. The pressure applied was 1.04 MPa and the velocity of the dispensing apparatus (displacement rate) was 0.7 mm/s. The feeding rate was about the same than the displacement rate. The curing rate was superior than the feeding rate and superior than the displacement rate.

### Example 3

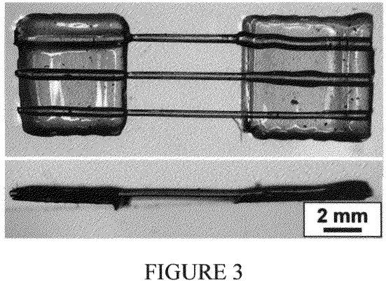

FIG. 3 shows 3 cured 0.5 wt. % C-SWNT/polyurethane nanocomposite straight filaments spanning over a 5 mm gap between two nanocomposite pads. To fabricate these outer pads, the positioning robot moved the 200 μm diameter extrusion nozzle at a height of 200 μm over a glass slide substrate making several parallel lines separated by a 100 μm distance. Because of the proximity of the deposited filaments and the absence of the UV radiation during this step, the material flows and coalesce with the previously deposited lines before curing to form the so-called pads. After curing with UV exposure, 3 filaments are suspended over the gap with the robot moving in a linear direction. The filaments first touch the films and then solidify while being extruded over the gap under UV exposure until the deposition apparatus reaches the end of the second pad. The applied pressure was 2.1 MPa. The displacement rate of the controlling robot was 8 mm/s during the film deposition, and 5 mm/s during the bridging filament deposition. The feeding rate was about the same than the displacement rate. The curing rate was superior than the feeding rate and superior than the displacement rate.

### Example 4

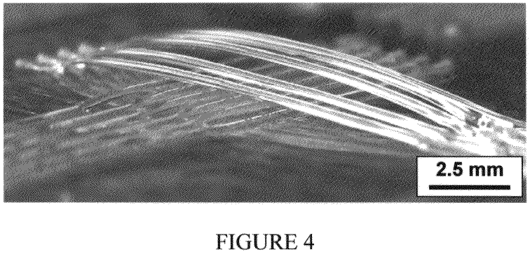

FIG. 4 shows two sets of curved cured polyurethane filaments suspended orthogonally over a substrate and over each other. The filament diameter is ˜250 μm and the spanning length is around 20 mm. The positioning robot was programmed in such a way that the 200 μm diameter extrusion nozzle traveled in a vertical plane perpendicular to the substrate. While maintaining the constant speed of 3.5 mm/s (displacement rate), the robot moved the nozzle for 1 mm at ˜50 μm over the glass substrate and then climbed to a height of 1.05 mm on a horizontal distance of 5 mm, went straight at the same height for 10 mm, went back down to the substrate on a distance of 5 mm, and finally moved parallel to the substrate at a height of 50 μm for another 5 mm. The same path was reproduced for the different filaments of the first set separated by 1 mm. For the second set, the same program was used with the exception that it was perpendicular to the first set and that the height of the middle 10 mm horizontal displacement was 500 μm higher than the first set. The pressure applied on the material for extrusion was 2 MPa. The feeding rate was about the same than the displacement rate. The curing rate was superior than the feeding rate and superior than the displacement rate.

It was thus shown that the methods previously disclosed can be used to prepare rapidly, efficiently and in a single step various freeform three-dimensional structures without the need for expensive tooling, dies, or lithographic masks.

The present disclosure has been described with regard to specific examples. The description was intended to help the understanding of the disclosure, rather than to limit its scope. It will be apparent to one skilled in the art that various modifications may be made to the disclosure without departing from the scope of the disclosure as described herein, and such modifications are intended to be covered by the present document.

1. A method of producing a structure, said method comprising:
depositing on a substrate, by means of a nozzle, a filament comprising a curable polymer, while exposing said filament to a radiation so as to cure said curable polymer, and while moving said substrate and said nozzle, with respect to one another, according to the x-axis, y-axis, and z-axis, in order to obtain a freeform three-dimensional structure having at least one point of contact with said substrate.

2. The method of claim 1, wherein said filament is fed through said nozzle at a feeding rate which is about the same than a displacement rate of the relative movement of said nozzle and said substrate with respect to one another.

3. The method of claim 2, wherein said feeding rate and said displacement rate are adjusted as a function of a curing rate of said polymer, said curing rate being higher than said displacement rate and being higher than said feeding rate.

4. The method of claim 1, wherein said filament is deposited on said substrate, by means of said nozzle, while exposing said filament that exits from said nozzle to said radiation, and while moving said substrate and said nozzle, with respect to one another, according to the x-axis, y-axis, and z-axis, so as to obtain said freeform three-dimensional structure, said depositing, and moving being made in such a manner that said structure has a single point of contact with said substrate, said point of contact being made at the beginning of said method.

5. The method of claim 4, wherein said point of contact is located at an extremity portion of said structure.

6. The method of claim 5, wherein said filament is fed through said nozzle at a feeding rate which is about the same than a displacement rate of the relative movement of said nozzle and said substrate with respect to one another, said feeding rate and said displacement rate being adjusted as a function of a curing rate of said polymer, said curing rate being higher than said displacement rate and being higher than said feeding rate.

7. The method of claim 6, wherein said filament further comprises at least one component chosen from an initiator, a pseudoplasticizer, and an enhancing property agent.

8. The method of claim 7, wherein said property enhancing agent is chosen from nanometric filamentary structures, nanopowders, and mixtures thereof, and said pseudoplasticizer is chosen from fumed silicas.

9. The method of claim 6, wherein said filament further comprises single-wall carbon nanotubes.

10. The method of claim 1, wherein said curable polymer is chosen from epoxy resins, polyesters, polyurethanes, poly(methyl methacrylates), acrylics, alkyds, amino resins, bismaleimides, furanes, phenolics, polyimides, vinyl esters, cyanate esters, silicones, arylzene resins, rubbers, synthetic rubbers, UV curable hydrogels, and mixtures thereof.

11. The method of claim 6, wherein said curable polymer is a polyurethane, said feeding rate is about 0.4 mm/s to about 10 mm/s, and said radiation is UV radiation.

12. The method of claim 1, wherein said method is carried out at room temperature under an ambient air atmosphere.

13. The method of claim 1, wherein said filament is deposited on said substrate, by means of said nozzle, while exposing said filament that exits from said nozzle to a radiation, and while moving said substrate and nozzle, with respect to one another, according to the x-axis, y-axis, and z-axis, so as to obtain said freeform three-dimensional structure, said depositing and moving being made in such a manner that said structure has at least two points of contact with said substrate, said at least two points of contact being at opposite end portions of said structure.

14. A method of producing a structure, said method comprising:
depositing on a substrate, by means of a nozzle, a composition comprising a curable polymer, optionally an initiator, optionally an enhancing property agent, and optionally a pseudoplasticizer, while exposing said composition to a radiation so as to cure said curable polymer, and while moving said substrate and said nozzle, with respect to one another, according to the x-axis, y-axis, and z-axis, in order to obtain a freeform three-dimensional structure having at least one point of contact with said substrate.

15. The method of claim 14, wherein a first portion of said composition is deposited on said substrate and exposed to said radiation so as to cure said curable polymer and then, at least one other subsequent portion of said composition is deposited on said first portion while exposing said at least one subsequent portion of composition to said radiation so as to cure said curable polymer, and while moving said substrate and said nozzle, with respect to one another, according to the x-axis, y-axis, and z-axis.

16. The method of claim 15, wherein said portions are deposited successively in a continuous manner, and wherein all portions subsequent to said first portion are deposited on a previous deposited and cured portion or at least partially cured portion.

17. The method of claim 16, wherein said composition is fed through said nozzle at a feeding rate which is about the same than a displacement rate of the relative movement of said nozzle and said substrate with respect to one another, said feeding rate and said displacement rate being adjusted as a function of a curing rate of said polymer, said curing rate being higher than said displacement rate and being higher than said feeding rate.

18. A method of producing a structure comprising:
bridging together a first substrate and a second substrate by depositing on said substrates, by means of a nozzle, a filament comprising a curable polymer, while exposing said filament to a radiation so as to cure said curable polymer, and while moving said nozzle, according to at least one of x-axis, y-axis, and z-axis, in order to obtain a freeform three-dimensional structure between said first and second substrates, said structure having at least one point of contact with said first substrate and at least one point of contact with said second substrate.

19. The method of claim 18, wherein said method comprises sequentially contacting said first substrate and then said second substrate, said deposition being carried out while exposing said filament to a radiation so as to cure said curable polymer, and while moving said nozzle towards said second substrate, according to at least one of the x-axis, y-axis, and z-axis, in order to obtain said freeform three-dimensional structure between said first and second substrates.

20. A method of producing a structure, said method comprising:
depositing on a substrate, by means of a nozzle, a filament comprising a curable polymer, while exposing said filament to a radiation so as to cure said curable polymer, and while moving said substrate and said nozzle, with respect to one another, according to at least two axes chosen from the x-axis, y-axis, and z-axis, in order to obtain a freeform three-dimensional structure having at least one point of contact with said substrate.
